(19) United States
(12) Patent Application Publication
(10) Pub. No.: US 2003/0222503 A1
(43) Pub. Date: Dec. 4, 2003

(54) Automatic voltage selection in a DC power distribution apparatus

(76) Inventors: Phillip L. Lam, Irvine, CA (US); John K. Araki, Tustin, CA (US)

Correspondence Address: LEONARD TACHNER, A PROFESSIONAL LAW, CORPORATION, 17961 SKY PARK CIRCLE, SUITE 38-E, IRVINE, CA, 92614

(21) Appl. No.: 10/375,450

(22) Filed: Feb. 27, 2003

Related U.S. Application Data
(63) Continuation-in-part of application No. 09/891,926, filed on Jun. 26, 2001, now abandoned.

(51) Int. Cl. H02J 1/00

(52) U.S. Cl. 307/38

(57) ABSTRACT

Provision is made in the housing of a host to provide a socket, or sockets, to which a peripheral piece of equipment can be connected for receiving directly from the host the low voltage DC power it requires. The socket(s) are connected electrically to the outputs of a power supply (or regulator) of a host for providing the low voltage needed to power the peripheral. The power supply may be mounted on the rear face of a computer. The principal feature of the invention resides in the use of a connector for connecting the host DC power to the peripheral DC power usage device. The connector comprises pins connected to a selected resistor in the power supply. The resistor value (i.e., resistance) is selected to produce a pre-determined control voltage which is fed back to a DC to DC converter in the host's internal power supply. The converter comprises a pulse width modulation control device. The control voltage determines the duty cycle (i.e., pulse width) of the modulation to reduce the output from a maximum voltage to an appropriate voltage suitable for the particular peripheral power usage device. Thus, by simply selecting the appropriate connector (or cable) having the proper pins correlated to a selected resistor previously installed in the power supply, the voltage level for the corresponding peripheral device is automatically selected. In an alternative embodiment, the DC power distribution apparatus of the present invention comprises a stand-alone unit having one or more universal ports for receiving a cable with a connector containing the appropriate pins for a selected DC power usage device.

### CROSS-RELATED APPLICATIONS

This application is a continuation-in-part of application Ser. No. 09/891,926 filed Jun. 26, 2001.

### BACKGROUND OF THE INVENTION

1. Field of the Invention

This invention relates to DC power distribution from a source to a peripheral device wherein the appropriate voltage level is selected automatically.

2. Prior Art

The market is replete with electronic equipment to which peripheral equipment is connected for cooperative action. The personal computer is one example of equipment to which peripheral equipment such as a FAX/modem and a LABEL scanner are connected for communication purposes. Another example is the television set to which a video cassette recorder (VCR) is connected; another, a stereo system. A tape drive, which might be connected to any of the above hosts, is a particularly familiar peripheral. Each piece of peripheral equipment is connected separately to an in-the-wall socket for power, as well as to the host, leading to a tangle of cords characteristic of any PC installation, stereo system or video system.

The peripherals often require different voltage levels for operation. Thus, five volt, nine volt, and 12 volt requirements are not uncommon. Consequently, not only are the power cords common, but they typically also require transformers. The transformers, in turn, not only further complicate the tangle of cords, but they also are expensive and not entirely reliable. Most individuals with systems of this type often find themselves complaining about the plethora of wires providing further impetus for the significant effort now being expended to develop wireless communication links between components. Still the tangle of power cords and transformers remains.

The most significant prior art known to the inventor hereof, consists of related disclosures of this inventor, namely, U.S. Pat. Nos. 5,838,554; 6,091,611; and 6,172,884. However, each of these patents requires installation of a resistor in a connector which significantly increases the cost of the connector. On the other hand, the present invention employs a simple connector configuration without any resistors.

### SUMMARY OF THE INVENTION

The invention is based on the recognition that host equipment such as a personal computer, a television set or a stereo tuner has an internal power supply and a voltage regulator which already provides low voltage requirements for internal components and can be adapted to permit the requisite low voltage power to be supplied to the peripheral equipment directly from the host equipment rather than separately through transformers to an in-the-wall supply. In this manner, the tangle of cords, characteristic of such systems, is considerably simplified. To this end, provision is made in the housing of a host to provide a socket, or sockets, to which a peripheral piece of equipment can be connected for receiving directly from the host the low voltage DC power it requires. The socket(s) are connected electrically to the outputs of the internal power supply (or regulator) of the host for providing the low voltage needed to power the peripheral. The power supply may be mounted on the rear face of the computer. The power supply may alternatively be internal with a DC power cable connected to a slot at the rear face of the computer providing for at least one DC socket there. In each such configuration, the principal feature of the invention resides in the use of a connector for connecting the host DC power to the peripheral DC power usage device. The connector comprises a selected resistor installed therein. The resistor value (i.e., resistance) is selected to produce a pre-determined control voltage which is fed back to a DC to DC converter in the host's internal power supply. The converter comprises a pulse width modulation control device. The control voltage determines the duty cycle (i.e., pulse width) of the modulation to reduce the output from a maximum voltage to an appropriate voltage suitable for the particular peripheral power usage device. Thus, by simply selecting the appropriate connector having a correlated resistor previously installed in the connector to the host rear panel, the voltage level for the corresponding peripheral device is automatically selected. Thus, the present invention obviates the prior art requirement for using separate power supplies for each peripheral. Moreover, the invention obviates the prior art requirement for fixed DC output voltage levels and for alterable levels which require manual selection such as by switch or jumper.

In one alternative embodiment, the DC power distribution apparatus of the present invention comprises a stand-alone unit having one or more universal ports for receiving a cable connector containing the appropriate pins for a selected DC power usage device. In another alternative embodiment, the cable is universal, but a unique connector attached to the cable, employs only the appropriate pins for a selected voltage. Each distinct voltage utilizes a unique connector.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIG. 1 is a block diagram illustrating the principals of the series of inventions which includes the present invention;

FIG. 2 is a rear panel drawing of a prior art apparatus;

FIG. 3 is a rear panel drawing of another prior art apparatus;

FIG. 4 is a schematic illustration of an internal power supply providing a DC power to an external cable having a resistor which determines the DC voltage at a rear panel in accordance with the invention;

FIG. 5, comprising FIGS. 5a and 5b, is a block diagram illustrating a preferred embodiment of the invention;

FIG. 6 is a simplified schematic illustration of the resistor selection feature of the invention;

FIG. 7 is a rear panel drawing of a preferred embodiment of the invention;

FIG. 8 is a drawing of an alternative embodiment comprising a stand-alone unit;

FIG. 9, comprising FIGS. 9a and 9b, is a detailed schematic drawing of a preferred embodiment;

FIG. 10 illustrates another alternative embodiment in which a cable having only selected pin connections determines the voltage at the power usage device;

FIG. 11 depicts the pin selections of FIG. 10 for various voltage selections; and

FIGS. 12 and 13 illustrate still another embodiment wherein the cable between the power supply and power usage device is universal, but a connector at the power usage device has selected pin connections to select a particular voltage.

### DETAILED DESCRIPTION OF ILLUSTRATIVE EMBODIMENTS OF THE INVENTION

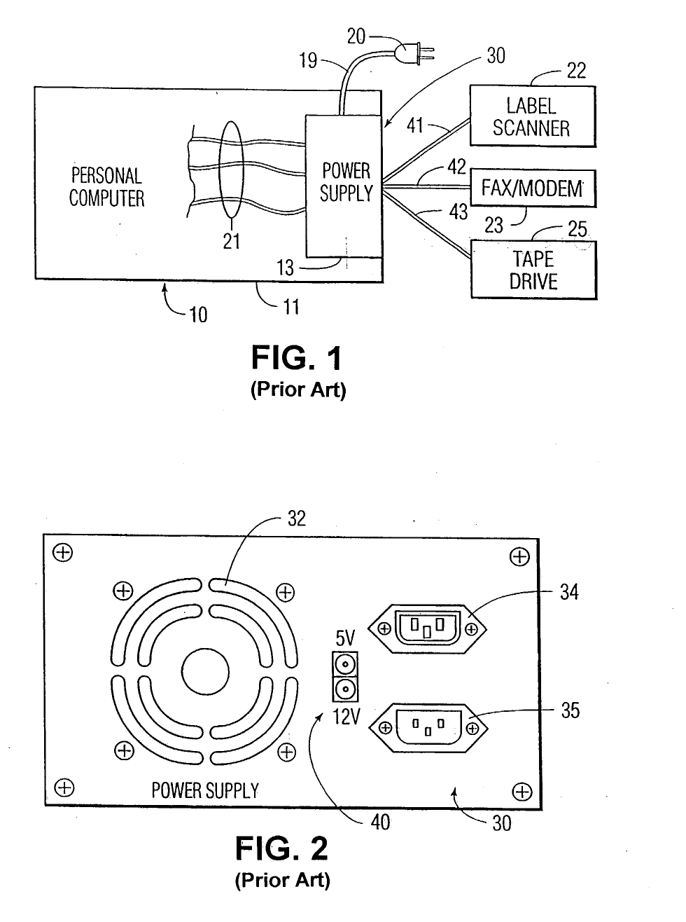

Reference will be made first to prior art FIGS. 1-3 to provide a basis for understanding the unique improvement of the invention.

FIG. 1 shows a personal computer 10 having a housing 11. A power supply 13 (with a voltage regulator (not shown)) is located within the housing. The power supply is connected to an in-the-wall socket (or equivalent) as indicated by cord 19 and plug 20. Power supply 13 is connected electrically to components (not shown) within the housing which constitute typical components for a computer for supplying power to those components as shown by wires 21. Typical peripherals for a computer are, for example, a LABEL scanner 22, a FAX/MODEM 23, and a tape drive (or CD ROM) 25 shown also connected to internal power supply 13.

FIG. 2 shows a face of a typical power supply for a personal computer. The power supply typically is secured within housing 11 with face 30 visible at an aperture in the computer housing.

The power supply includes a fan which is secured behind the pattern of curved openings 32. Also, plugs 34 and 35 are available for connection to the computer monitor and to wall power, respectively.

Additional sockets 40 are provided in the computer housing, or in the face of the internal power supply if exposed at the computer housing, for direct connection of wires 41, 42 and 43 connecting the LABEL scanner, FAX/MODEM and tape drive respectively of FIG. 1 for supplying the low voltage requirements for those peripherals in the absence of connection to in-the-wall sockets and in the absence of associated power supplies.

Each of sockets 40, illustratively, is shown as circular with a central pin for conforming to popular connector shapes for the illustrative peripherals. Of course, other connector shapes could be provided for connection to cables of alternative configurations. What is necessary, is that low voltage outputs from a host's internal power supply are connected to newly provided sockets at the housing face of the host.

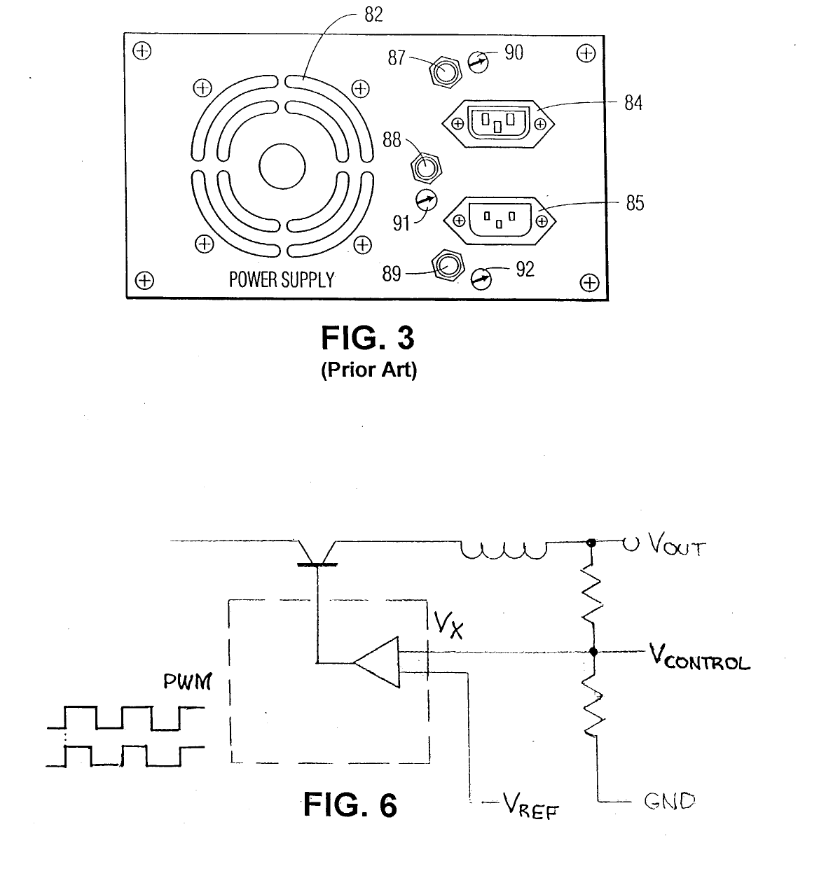

FIG. 3 illustrates an example of the prior art wherein a power supply configuration is of the type shown in FIG. 2 except that the voltage at each socket is variable. Specifically, the power supply includes a fan which occupies a position behind the pattern of curved openings 82. Also, plugs or sockets 84 and 85 are available for connection for the computer monitor and to wall power respectively.

In the configuration of FIG. 3, each of the sockets 87, 88 and 89, for the external connection of peripheral equipment, is associated with a variable voltage control 90, 91 and 92, respectively, for selecting an appropriate voltage at the associated socket.

Although the aforementioned prior art is described in connection with a personal computer, FIG. 1 could also represent a stereo system with associated peripherals or a television system with a video cassette and the like. In each instance, additional sockets, or connectors, are provided at the housing face for external connection of peripherals for supplying power thereto.

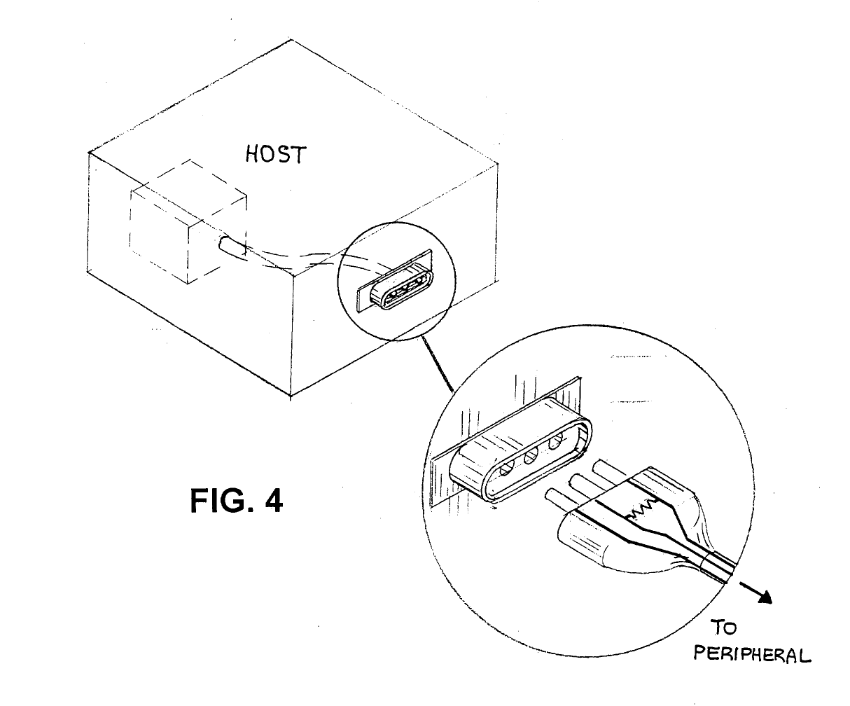

Referring to FIGS. 4-7, it will be seen that unlike the aforementioned prior art, the present invention provides for automatic selection of the appropriate DC voltage by employing a selected resistor in the connector of the cable which mates with the host's power supply. The value of the resistor determines the voltage by applying a proportional control voltage V_{control} to an input of a pulse width modulator (PWM) which may for example, be a Texas Instruments TL 494 Pulse-Width-Modulation Control Circuits integrated circuit chip. The PWM controls the pulse width and thus the duty cycle of a switching signal in a DC to DC converter, the input to which is a regulated maximum DC voltage (i.e., 23 Volts). The higher the pulse duty cycle, the closer the output voltage to the maximum available and the lower the duty cycle, the closer the output voltage to the minimum. In the illustrated embodiments, the available output DC power is provided at two distinct ports or connectors, one for a higher range of voltage (i.e., 9 Volts to 19 Volts) and another for a lower range (i.e., 3 Volts to 9 Volts). Thus, the illustrated embodiments have two separate pulse-width modulation control circuit chips connected into two distance circuits, one for each range of output voltage.

FIG. 4 illustrates a version of the preferred embodiment wherein a host system such as a desk-top computer 100 having a chassis 101, provides a DC power source 102, the output of which is connected by an internal cable 104 to a panel connector 106. A cable 108 has a mating connector 110 in which there is a selected value resistor 112 installed. Cable 108 transfers the DC power to a peripheral apparatus (not shown) where the cable may have a second connector or may be hard wired into the peripheral apparatus.

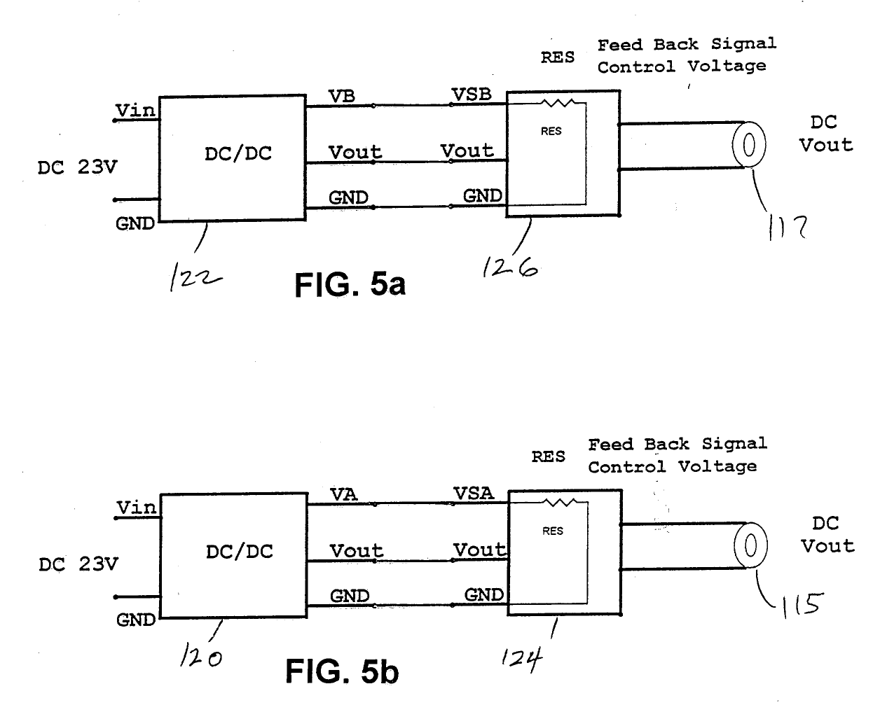

In FIGS. 5a and 5b, the aforementioned dual range DC output configuration is illustrate in block diagram form. Each of the two available DC outputs 115 and 117 derives power from a corresponding DC to DC converter 120 and 122. The input to each DC to DC converter is derived from a standard AC to DC converter (not shown) which, in the illustrated embodiment, provides a regulated 23V DC at V_{IN}. Each DC to DC converter 120 and 122 provides three lines, namely V_{A} (V_{B}), V_{OUT} and GND (ground). These three lines are connected to corresponding connectors 124 and 126 at inputs V_{SA} (V_{SB}), V_{OUT} and GND. A resistor RES is connected across V_{SA} (V_{SB}) and GND while V_{OUT} and GND provide the output of each connector 115 and 117, respectively. The resistor RES has a selected value of resistance which provides a feedback signal from V_{SA} of the connectors 124 and 126 to the V_{A} line of the converters 120 and 122. This feedback signal is the control voltage (V_{CONTROL}) which determines the voltage level of V_{OUT}.

As shown in FIG. 6, the control voltage is applied to a pulse width modulation circuit and controls the duty cycle of the modulator by altering the pulse width in accordance with the selected value of RES.

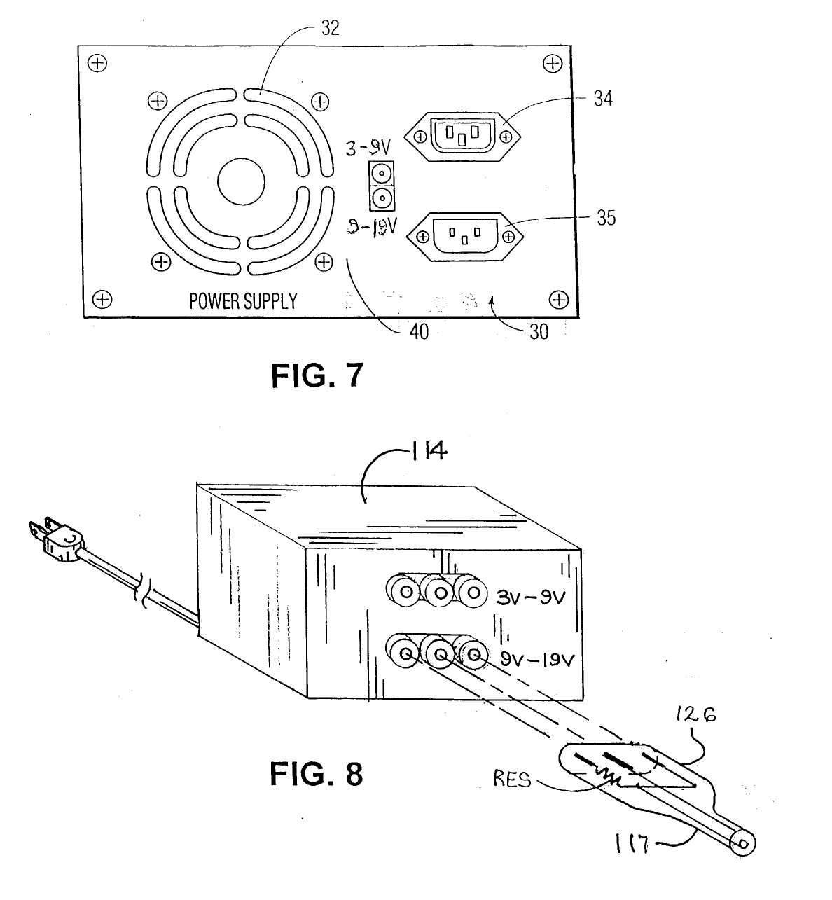

The invention herein may be implemented in a variety of different configurations. The embodiment of FIG. 7 illustrates an implementation in the chassis of a computer wherein the DC voltage outputs are available at a rear panel for use by computer peripherals. The embodiment of FIG. 8 illustrates an implementation as a stand-alone; “Universal” DC power source 114 having a plurality of connectors 126, each having its own selected resistor RES for use with a particular DC power usage device by connection at output 117.

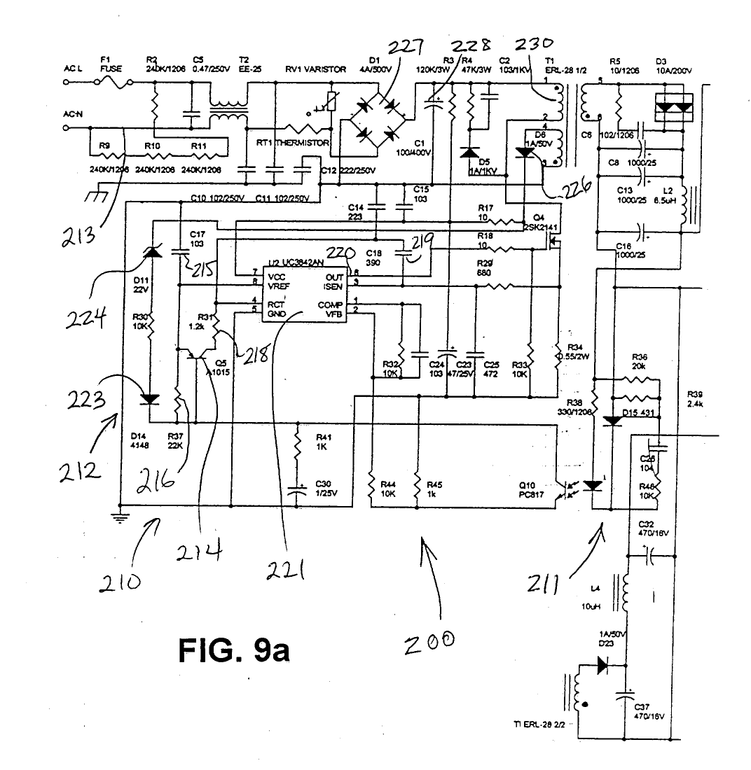

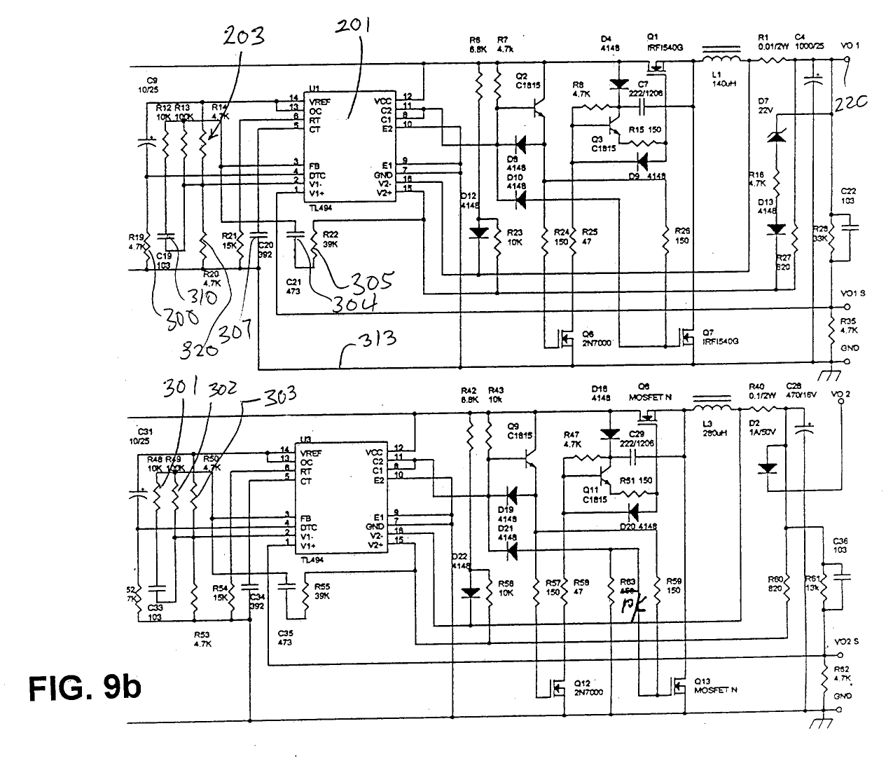

In order to provide ample details of the disclosed embodiment, a schematic of an actual operational configuration of the invention is shown in FIGS. 9A and 9B and the significant components thereof are listed in Table 1 below.

TABLE I

| NUM- | | | | | |
|---|---|---|---|---|---|
| BER | PART | VALUE | SIZE | LOCATION | USE |
| 34 | MOSFET | IRFZ24N | | | |
| 35 | transistor | 2N7000 | SOT-220 | Q6, 12 | 2 |
| 36 | DIODE | 3 A/50 V | TO-252 | Q11, 16 | 2 |
| 37 | RES. | 1.2K | 0603 | R3 | 1 |
| 38 | RES | 22K | 0603 | R4 | 1 |
| 39 | RES | 2.2K | 0603 | R5 | 1 |
| 40 | RES | ? | 0603 | R6 | 1 |
| 41 | RES | 330 OHM | 0603 | R7 | 1 |
| 42 | RES | 10K | 0603 | R2, 8.9.30, | 8 |
| | | | | 32, 35, 55, 67 | |
| 43 | RES | 330K | 0603 | R11A, B, C | 3 |
| 44 | RES | 10 OHM | 0603 | R1, 33 | 2 |
| 45 | RES | 470 OHM | 0603 | R10 | 1 |
| 46 | RES | 47K/3 W | DIP | R12 | 1 |
| 47 | RES | 20K | 0603 | R14 | 1 |
| 48 | RES | 10/.25 W | DIP | R15 | 1 |
| 49 | RES | 120K/13 W | DIP | R65 | 1 |
| 50 | RES | 0.02/3 W | DIP | R41 | 1 |
| 51 | RES | 100K | 0603 | R19, 44 | 2 |
| 52 | RES | 33K | 0603 | R20 | 1 |
| 53 | RES | 150 OHM | 0603 | R22, 24, 29, | 6 |
| | | | | 47, 49, 54 | |
| 54 | RES | 47 OHM | 0603 | R23, 48 | 2 |
| 55 | RES | 620 OHM | 0603 | R18 | 1 |
| 56 | RES | 15K | 0603 | R21, 46 | 2 |
| 57 | RES | 1.5K | 0603 | R25, 50 | 2 |
| 58 | RES | 4.7K | 0603 | RR26, 27, | 11 |
| | | | | 28, 37, 39, | |
| | | | | 51, 52, 53, | |
| | | | | 57, 59, 63 | |
| 59 | RES | 0.12 | DIP | R31 | 1 |
| | | OHM/2 W | | | |
| 60 | RES | 680 OHM | 0603 | R34 | 1 |
| 61 | RES | 250K | 0603 | R37 | 1 |
| 62 | RES | 39K | 0603 | R40, 60 | 2 |
| 63 | RES | 1K/2 W | 0805 | R41A, B, C, | 6 |
| | | | | R61A, B, C | |
| 64 | RES | 0.22/2 W | DIP | R61 | 1 |
| 65 | RES | 1K | 0603 | R43, 62, 64 | 3 |
| 66 | RES | 12K | 0603 | R45 | 1 |
| 67 | RES | 1M | 0603 | R58 | 1 |
| 68 | RES | 6.8K | 0603 | R66 | 1 |
| 69 | transformer | ERL28 | | T1 | 1 |
| 70 | TR1 | LMO3 | | TR1 | 1 |
| 71 | IC | UC3842 | | U1 | 1 |
| 72 | IC | TL494 | | U2, U3 | 2 |
| 73 | ZENER | 25 V | SMD | ZD1 | 1 |
| 74 | ZENER | 22 V | SMD | ZD2 | 1 |
| 75 | AC | 0712-2-PP | | CN2 | 1 |
| | SOCKET | | | | |
| 76 | PCB | | | | 1 |

FIG. 9 shows a block 200 which comprises a standard AC/DC converter. FIG. 9 also shows a block 201 representing a control chip which is commercially available from Texas Instruments as Part Number TL 494 CNS the organization and operation of which is represented in the functional block diagram of FIG. 5 available from the manufacture.

Block 203 in FIG. 9 represents the resistor network segment or incomplete resistor network in accordance with the principles of this invention.

The converter 200 of FIG. 9 is essentially a standard AC/DC converter comprising an AC side 210 and a DC side 211. Any standard AC/DC converter could be used herein. The converter shown has an input control arrangement 212 for providing a shaped response to the AC input signal on line 213. Input control arrangement 212 includes a transistor 214 with the emitters connected between a capacitor 215 and a resistor 216. The collector of transistor 214 is connected via resistor 218 and capacitor 219 to the output 220 of an AC/DC connector chip 221. Chip 221 is commercially available from UNITRON Corporation as Part Number U2UC3842 AN. The input control arrangement also includes a diode 223 and a ZENER diode 224 connected in series between resistor 216 and an input to (reverse) diode 226 and to transformer 230. The input control arrangement 212 is operative to protect against start up overvoltages. The remainder of the AC/DC circuit is entirely standard.

Network 203 (along with chip 201) occurs in each of two essentially identical arrangements, one for a relatively high voltage output (for example 19 Volts) and one for a relatively low voltage output (for example 9 Volts) illustratively useful for different classes of portable electronic equipment such as cell phones, pagers, portable game devices and laptops, PDA's, portable DVD/CD players for high & relatively low voltage requirement respectively. Only one of these arrangements is described below.

Resistor network segment 203 of FIG. 9 comprises a parallel arrangement of resistors 300, 301, 302 and 303 connected via a capacitor 304 and a resistor 305 to the V2+ input of control chip 201. Resistor 303 also is connected to inputs V_{REF} and OC of chip 201; resistor 302 is connected to input VI− and resistor 301 is connected via a capacitor 310 also to input VI−. Resistor 300 is connected between-input DTC of chip 201 and ground 313. Resistor 303 also is connected to ground 313 via resistor 320 and resistor 301 is connected via capacitor 310, resistor 302, capacitor 304 and resistor 305 to the V2+ port of chip 201 and V_{OUT} 220.

A voltage selector module in the form of a connector, connects to the control chip at C1-E1 (or C2-E2) depending on whether a high or relatively low voltage is required. The voltage selector module includes a resistor which determines the voltage for a connected piece of equipment corresponding to the resistor in the module.

When the selector module is connected, it signals the control chip to provide the specified voltage. That voltage is supplied at the V_{OUT} port 322.

The diode and circuit arrangement to the right of chip 201 in FIG. 9B is standard configuration for controlling heat loss with components selected for that purpose.

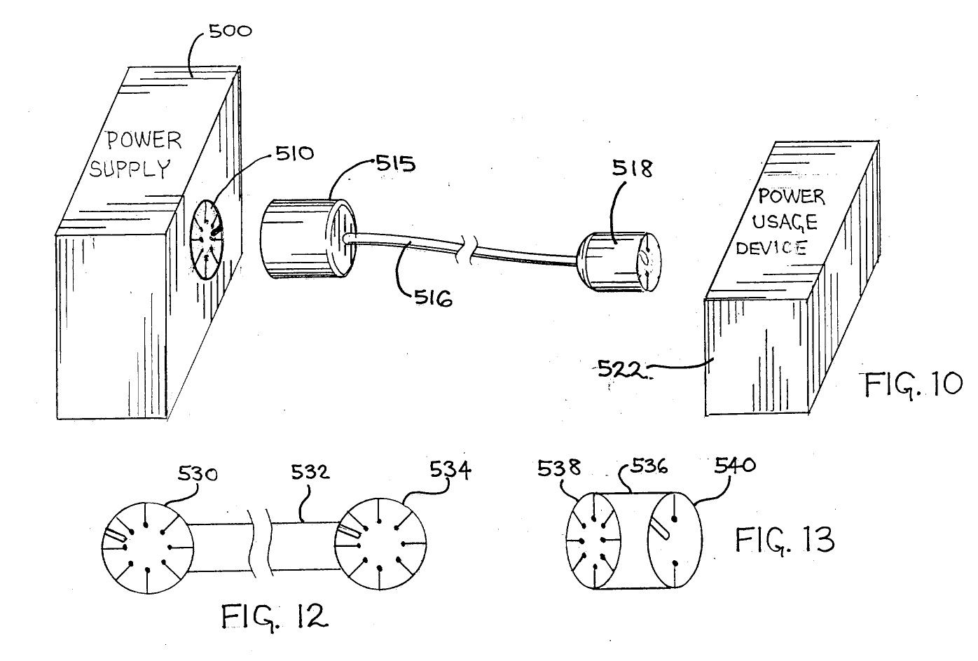

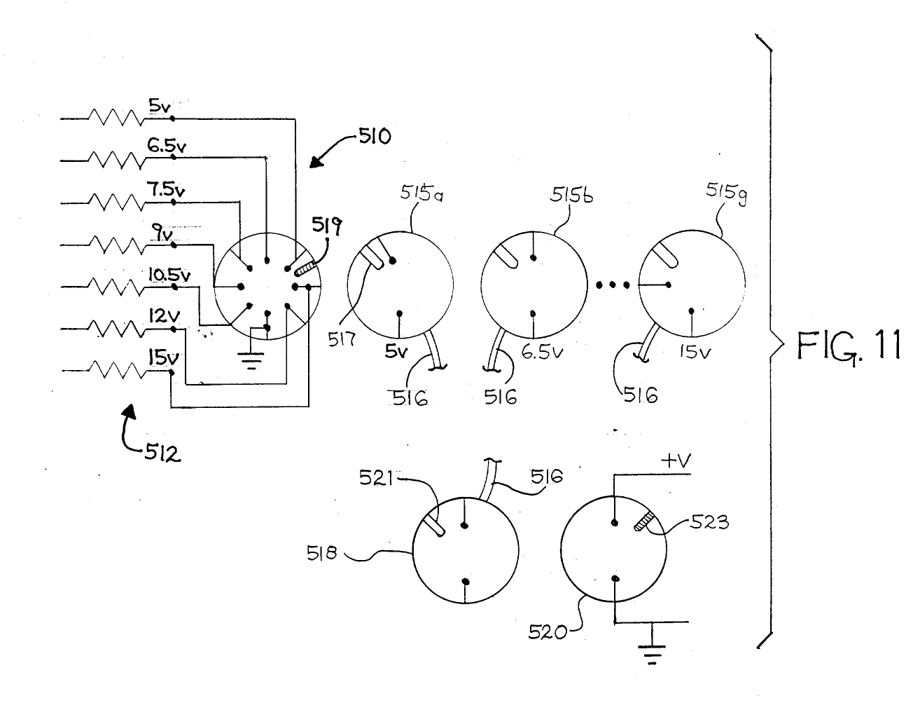

Reference will now be made to FIGS. 10 to 13 which depict two alternative embodiments wherein the voltage selection resistors are retained in the power supply while pins in the cable or in the connector to the power usage device, determine the voltage. By way of illustration in FIGS. 10 and 11, a power supply connector 510 provides seven distinct DC voltages and a ground. The voltages are determined by a network 512 of differently valued resistors in the power supply. The voltage at the power usage device 522 is determined by which of the pins in connector 510 is connected to a usage device connector 520. This, in turn, is determined by cable 516 by means of connector 515. Depending on which configuration of pins is employed, i.e., 515a, 515b . . . 515g, one of the resistors 512, and only one, is selected to set the voltage. In FIG. 11, the 515a cable connector selects 5.0 volts; the 515b cable connector selects 6.5 volts; and the 515g cable connector selects 15 volts. A key 517 in the cable connector 515 and 519 in the power supply connector 510, prevents erroneous voltage selection. Similar keys 521 and 523 are in the connectors 518 and 520.

Another version of this automatic voltage selection technique is shown in FIGS. 12 and 13. In this version a universal cable 532 has all pins in respective connectors 530 and 534. A conversion device 536 has a mating connector 538 and a two-pin voltage selection connector 540, the latter being comparable to connector 515 of FIGS. 10 and 11.

Having thus disclosed preferred illustrative embodiments of the invention, it being understood that various modifications, additions and alternative applications are contemplated and that the scope of protection hereof is limited only by the appended claims and their equivalents, what is claimed is:

1. A DC power distribution apparatus comprising:
a source of DC power for generating a maximum DC voltage;
a controller for modifying the DC power source output voltage to a level lower than said maximum voltage, said controller being responsive to a control voltage for selecting said lower level output voltage;
an output connector for connecting said power distribution apparatus to a DC power usage device;
a resistor network located in said apparatus and having different selected values of resistance for providing different ones of said control voltage to select said lower level output voltage that is appropriate for said DC power usage device; and
a plurality of cables for connecting said output connector to said power usage device, each said cable being configured to connect one and only one said resistance for selection of a lower level output voltage.

2. The DC power distribution apparatus recited in claim 1 wherein said DC power source comprises a DC to DC converter.

3. The power distribution apparatus recited in claim 1 wherein said controller comprises a pulse width modulator and wherein said control voltage determines the duty cycle of said pulse width modulator.

4. The power distribution apparatus recited in claim 3 wherein said duty cycle is determined by a modification of the pulse width of said pulse width modulator.

5. The power distribution apparatus recited in claim 1 further comprising a computer chassis and wherein said apparatus is located within said computer chassis.

6. The power distribution apparatus recited in claim 5 wherein said DC power usage device comprises a computer peripheral device.

7. A DC power distribution apparatus comprising:
a source of DC power for generating a maximum DC voltage;
a controller for modifying the DC power source output voltage to a level lower than said maximum voltage, said controller being responsive to a control voltage for selecting said lower level output voltage;
a plurality of connectors for connecting said power distribution apparatus to respective selected DC power usage devices; and
a resistor network located in said apparatus and having a plurality of selected values of resistance for providing said control voltage to select said lower level output voltage that is appropriate for said each selected DC power usage device;
each said connector providing automatic selection of one of said resistances appropriate for a corresponding selected DC power usage device.

8. The DC power distribution apparatus recited in claim 7 wherein said DC power source comprises a DC to DC converter.

9. The power distribution apparatus recited in claim 7 wherein said controller comprises a pulse width modulator and wherein said control voltage determines the duty cycle of said pulse width modulator.

10. The power distribution apparatus recited in claim 9 wherein said duty cycle is determined by a modification of the pulse width of said pulse width modulator.

11. The power distribution apparatus recited in claim 7 further comprising a computer chassis and wherein said apparatus is located within said computer chassis.

12. The power distribution apparatus recited in claim 11 wherein at least one of said DC power usage devices comprises a computer peripheral device.

13. A universal adapter system for supplying DC power to any of a plurality of DC power usage devices, the system comprising:
first and second components, said first component comprising a source of maximum DC output voltage including a pulse width modulator and said second component comprising a detachable connector, said connector including a selected pin configuration for providing a control voltage for controlling the duty cycle of said pulse width modulator for selecting a control voltage less than said maximum output voltage; said source having a network of multiple resistors, each resistor creating a unique control voltage, each said pin configuration automatically selecting one of said resistors.

14. The system recited in claim 13 wherein said first component includes at least one output socket having a universal configuration; and
wherein said connector includes a mating universal configuration at a first end thereof and a unique pin configuration at a second end thereof for mating with a selected power usage device.

15. A DC power distribution apparatus comprising:
an AC to DC converter;
a DC to DC converter connected to said AC to DC converter and having an output voltage determined by a pulsed signal;
a pulse width modulator for generating said pulsed signal and having a control voltage input, the voltage level of which determines a parameter of the pulsed signal; and
an accessible port providing an output of said DC to DC converter and a control voltage terminal for receiving said control voltage input.

16. The DC power distribution apparatus recited in claim 15 wherein said parameter is the duty cycle of said pulsed signal.

17. The DC power distribution apparatus recited in claim 15 wherein said control voltage input is derived from said converter output fed back to said pulse width modulator through a resistor of a selected value, said resistor being one of a plurality of resistors.

18. The DC power distribution apparatus recited in claim 17 wherein said resistor is contained in said apparatus and is connected to said accessible port for determining voltage level of DC power distributed to another apparatus.

19. A method for distributing DC power to any one DC power usage device of a plurality of DC power usage devices having different DC voltage requirements; the method comprising the following steps:
a) providing a source of DC power for generating a maximum DC voltage;
b) modifying the DC power source output voltage to a level lower than said maximum voltage by applying a selected control voltage to a pulse width modulator having a pulse duty cycle dependent upon said control voltage;
c) connecting said output voltage to any selected one of said plurality of DC power usage devices by a connector; and
d) placing a resistor network in said DC power source, each resistor in said network being selected to provide a control voltage for modifying said DC power source output voltage to correspond to the appropriate DC voltage for powering said selected one of said plurality of DC power usage devices; and
e) configuring said connector to select one and only one of said resistors suitable for a selected one of said DC power usage devices.

20. The method recited in claim 19 wherein step a) comprises the step of providing a DC to DC converter in said source.
